(19) United States
(12) Patent Application Publication
(10) Pub. No.: US 2002/0045392 A1
(43) Pub. Date: Apr. 18, 2002

(54) Weatherable outdoor multi-axial fabric

(75) Inventors: William W. White, Mooresville, NC (US); John B. Bell, Tryon, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: John Boyle & Company, Inc., Statesville, North Carolina

(21) Appl. No.: 09/940,863

(22) Filed: Aug. 28, 2001

Related U.S. Application Data
(60) Provisional application No. 60/228,700, filed on Aug. 29, 2000.

(51) Int. Cl. B32B 5/26; B32B 27/04; B32B 27/12

(52) U.S. Cl. 442/32; 442/1; 442/38; 442/49

(57) ABSTRACT

The new fabric according to the present invention provides a great advance over conventional tent fabrics of both the types discussed above and others. In particular, the fabric, according to the present invention, possesses improved strength and durability for withstanding the external and internal forces placed upon it while still maintaining an economical cost of manufacturing and a light enough weight to be maneuverable. The fabric advantageously possesses multiple nonwoven axes that bear the load placed on them by external and internal forces.

### CROSS-REFERENCE TO RELATED APPLICATIONS

This application claims the benefit of U.S. Provisional Application No. 60/228,700, filed Aug. 29, 2000.

### FIELD OF THE INVENTION

The present invention relates to weatherable outdoor soft composites, and more particularly relates to weatherable outdoor fabrics which may be used for covering tent structures and the like.

### BACKGROUND OF THE INVENTION

Weatherable outdoor fabrics have many uses in temporary, permanent or semipermanent structures. For example, such fabrics form a flexible covering for tents and other structures used for weddings, festivals and other special events. These fabrics may be used in other situations, however, such as for inflatable tents or as covering for awnings and canopies. A fabric needs specific qualities to be useful in such applications. In particular, many modem architectural designs incorporate curved lines in fabric coverings, and such fabrics should be capable of being dimensionally stable along these curved lines.

Tents and other structures used for special events typically include some rigid elements onto which a flexible fabric is draped or connected. The fabric protects the tent's occupants from the weather. To accomplish this task, the fabric typically is relatively lightweight for ease of erection and durable to withstand the elements. The fabric is preferably waterproof to provide shelter from rain or snow and is also substantially opaque to provide protection from the sun. The fabric should be aesthetically pleasing as well.

In addition to protection from environmental conditions, the fabric often adds to the structural integrity of the tent. Many times tensions within the fabric create forces which aid in holding the rigid elements of the tent in proper place. These tensions, as well as other external forces, place stress on the fabric in many directions. The stress caused by such forces tends to instigate fabric deterioration and fatigue, preventing the fabric from performing its intended duties. The stress, in combination with the fabric fatigue and other external forces, may effect tearing of the fabric rendering it useless.

Conventional fabrics used in tents and other similar structures comprise traditional woven fabrics which are laminated, coated, or specially finished to instill the desired qualities. Traditionally, a heavy duck fabric or canvas with a waterproofing finish has been used in tent construction. These fabrics are strong and durable and can withstand the forces placed on them while in use. These fabrics, however, are expensive to make, prone to rotting and, because of their weight, are often difficult to manipulate.

In recent years, laminate woven fabrics have been proposed as tent-making fabrics. These fabrics include a lightweight woven scrim layer such as a polyester fabric with a layer of polymer coating material applied to both sides to add cohesion, opaqueness, and water repellency. These fabrics are inexpensive and lightweight enough for easily maneuverability, but these fabrics also have a tendency to tear under the stress placed on them in the tent environment. The warp and weft yarns of the woven scrim form 90° angles. The fabric possesses high strength in the direction of the yarns. However, fabrics used in tent construction often undergo stresses in the bias directions between the 90° angles formed by the yarn such as adjacent a grommet or tent pole. Similarly, in architectural designs requiring curved lines, it is difficult to align warp or weft directions with the curved lines, thus sacrificing dimensional stability. Further, even in the directions of the yarns, the crimp of the yarns caused by weaving or interlacing the yarns together lessens the dimensional stability of the fabric.

Accordingly, a need currently exists for an improved weatherable outdoor fabric for use in flexible structures which is strong and durable while still being lightweight enough to be manageable and economical enough to be cost-effective.

### SUMMARY OF THE INVENTION

The new fabric according to the present invention provides a great advance over conventional tent fabrics of both the types discussed above and others. In particular, the fabric, according to the present invention, possesses improved strength and durability for withstanding the external and internal forces placed upon it while still maintaining an economical cost of manufacturing and a light enough weight to be maneuverable. The fabric advantageously possesses multiple nonwoven axes that bear the load placed on them by external and internal forces.

### BRIEF DESCRIPTION OF THE DRAWINGS

Some of the objects and advantages of the invention having been stated, others will appear as the description proceeds, when taken in connection with the accompanying drawings, in which:

FIG. 1 is a top view of a segment of a multi-axial nonwoven weatherable fabric;

FIG. 1A is an enlarged sectional view of a segment of a multi-axial nonwoven weatherable fabric along line 1A-1A of FIG. 1;

FIG. 2 is a top view of a nonwoven scrim with the warp yarns oriented in the 0° direction and weft yarns oriented in the 90° direction;

FIG. 3 is a top view of a nonwoven scrim with the warp yarns oriented in the +45° direction and weft yarns oriented in the −45° direction;

FIG. 4 is a side view of a process for making a multi-axial nonwoven fabric; and

FIG. 5 is a top view of a tri-axial nonwoven weatherable fabric.

### DETAILED DESCRIPTION

It is to be understood by one of ordinary skill in the art that the present discussion is a description of exemplary embodiments only, and is not intended as limiting the broader aspects of the present invention. Rather, these embodiments are provided so that this disclosure will be thorough and complete and fully convey the scope of the invention to those skilled in the art.

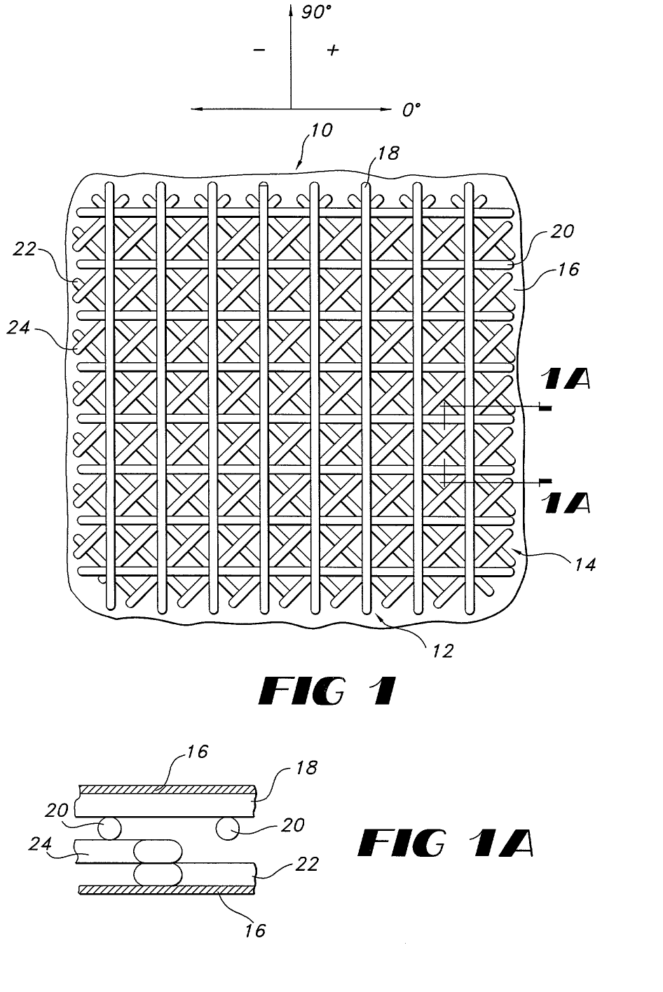

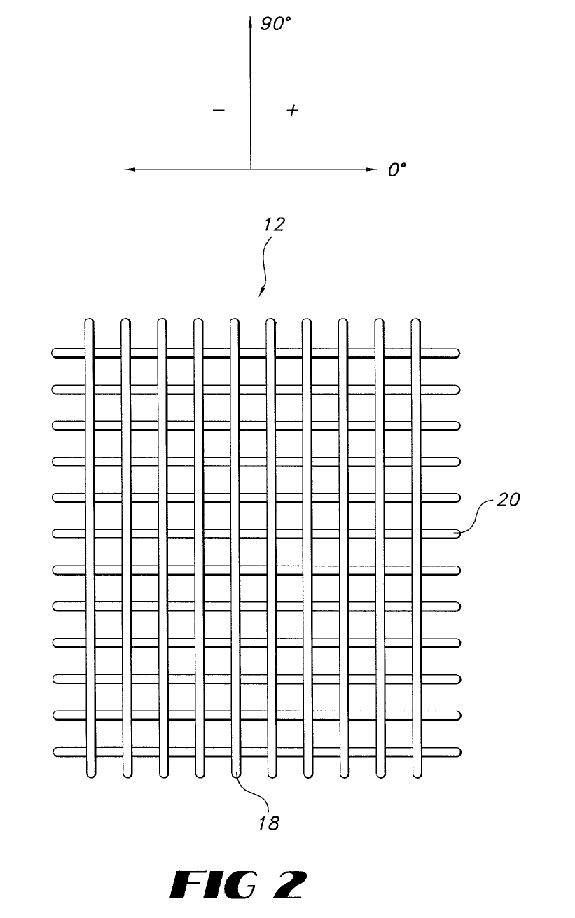

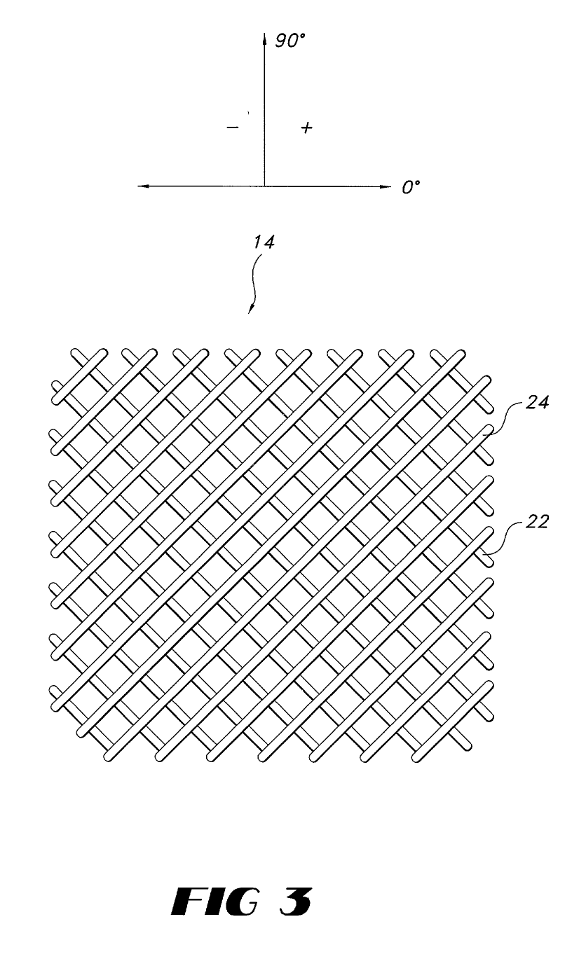

FIG. 1 depicts a top view of a presently preferred embodiment of the current invention. The fabric 10 includes two scrim layers 12 and 14 with one being placed on top of the other. The scrim of each layer consists of two sets of yams perpendicular to each other. As in FIG. 2, a first scrim 12 has a warp yam set 20 oriented in the 0° direction and a weft yam set 18 oriented in the 90° direction. The second scrim 14, as seen in FIG. 3, possesses a warp yam set 24 in the +45° direction and a weft yam set 22 in the −45° direction. The scrims may be held together either through adhesive bonding, stitch-bonding, knit-bonding, skewing or by being laid on top of one another forming a multi-layered scrim fabric and being held together as discussed below. In particular, a continuously knitted warp yam could be used to hold the various yams together. FIGS. 1 and 1A show transparent outer layers 16 coating the two scrims 12 and 14. A web, foil, film, coating, or other outer layer may cover the scrims, and each type outer layer may contain pigmentations to increase the fabric's opaqueness and aesthetic appeal. The outer layers may be preformed or coated or extruded in-line on the scrim layers.

The outer layers may consist of a wide range of polymers, but preferably a thermoplastic polymer is used. The characteristics of certain vinyl compounds, such as polyvinylidenefluoride (PVDF) or polyvinylchloride (PVC), make them ideal for use as the outer layers for the multi-axial fabric. They possess flexibility, durability and the ability to repel water and fire, and are relatively inexpensive. For example, these vinyl compounds are more weatherable and flame resistant than commonly used polyethylene. The outer layer may be applied on one or both sides of the multi-layered scrim fabric. The outer layers can be adhesively bonded, heat-bonded, laminated or extruded onto the multi-layered scrim fabric. The outer layers contribute to the opaqueness, weatherability and the overall integrity of the multi-axial nonwoven fabric.

As shown in FIG. 2, a first scrim 12 contains a warp yam set 20 with a 0° orientation that is disposed beneath a weft yam set 18 with a 90° orientation. Unlike the conventional scrims used in the making of structural fabrics, neither the warp nor weft yam sets 20 and 18 interlace, interweave, or interlock with one another. Instead, the yams within each scrim layer are bonded together, one set on top of the other, preferably by some type of adhesive. Adhesively bonding the warp and weft yams together contributes integrity to the scrim, ideally using some type of emulsion or spray coating, such as PVA. By not interlacing, interweaving, or interlocking the warp and weft yams, the dimensional stability of the fabric is not diminished in the direction of the yams because crimp is not added to the yams. Crimp in the yams, inherent in woven or knitted fabrics, causes less dimensional stability in the direction of the yams. By having the yams oriented in a straight line without any crimping, the fabric possesses increased stability in the direction of the yams and the yams have the ability to bear an increased load in that direction.

FIG. 3 depicts the second scrim 14, which contains two sets of yams extending in the bias directions. A warp yam set 24 extends in a +450 direction that is disposed on top of a weft yam set 22 extending in a −4520 direction, although other angles may be desirable. LIBA, Maschinenfabrik, GmbH of Naila, Germany, and others manufacture machines to create such a scrim. As with the first scrim 12 (FIG. 2), the yams are bonded together, and the warp and weft yam sets 24 and 22 of the second scrim 14 do not interlace, interweave, or interlock. This construction provides the benefits, as described above, of having greater dimensional stability and increased load bearing capability in the direction of the yams. Since the yams are oriented in the +45° and −4520 directions, the second scrim 14 is stronger in the bias directions as compared to the first scrim 12, which is stronger in the 0° and 90° directions.

By combining the two scrims in the fabric of the present invention, the fabric has two advantages over conventional structural fabrics. Firstly, the fabric is advantageously much stronger than other structural fabrics while still maintaining a light enough weight to be maneuverable. The fabric bears greater loads in the conventional directions of 0° and 90° and handles much greater loads in the bias directions of the fabric, thereby increasing the durability of the fabric by increasing the fabric's ability to endure both the internal and external forces that are placed upon it. Secondly, the construction of the scrims is less expensive than conventional woven scrim because of the increased speed of manufacture. Since the warp yams lay on top of weft yams, or vice versa, and they are then bonded in heat- or adhesive-bonding process, the speed of the process increases substantially over conventional weaving processes. The lowered cost of scrim manufacturing created by the increased productivity of the process allows the fabric of the present invention to financially compete with other structural fabrics.

The warp and weft yarns used in both scrims can comprise a wide range of multifilament or monofilament natural or synthetic fibers. In a preferred embodiment, the yams are comprised of a thermoplastic material, such as polyester or nylon. Polyester has a favorable cost compared to the tensile and tear strength it possesses. The size of the yams may vary from 5 denier to 2000 denier within different fabrics. Advantageously, the yarn size is around 1000 denier. This size allows the yam to be strong enough to withstand the forces placed upon it, while being flexible enough to respond to any harsh bending the fabric may encounter. The yams can also be individually coated to achieve certain properties.

In a preferred embodiment, each scrim is a unitary pre-manufactured nonwoven structure. The scrims, however, may be manufactured as part of the process of making the fabric although fabric width may be limited at certain manufacturing speeds due to machine constraints. Each of the warp yams in both scrims may be spaced an equal distance from the next or it may prove beneficial to have a higher concentration of yams along certain lines of the fabric where an increase in load is expected, such as a point in the fabric where a grommet or a pole support will be located. The weft yams also may be spaced in a uniform or non-uniform fashion. Preferably, the distance between each of the warp yams in the warp yam set for both scrims is the same as the distance between each of the weft yams in the weft yam sets. In a preferred embodiment, the pre-manufactured scrim contains approximately nine ends per inch by nine picks per inch.

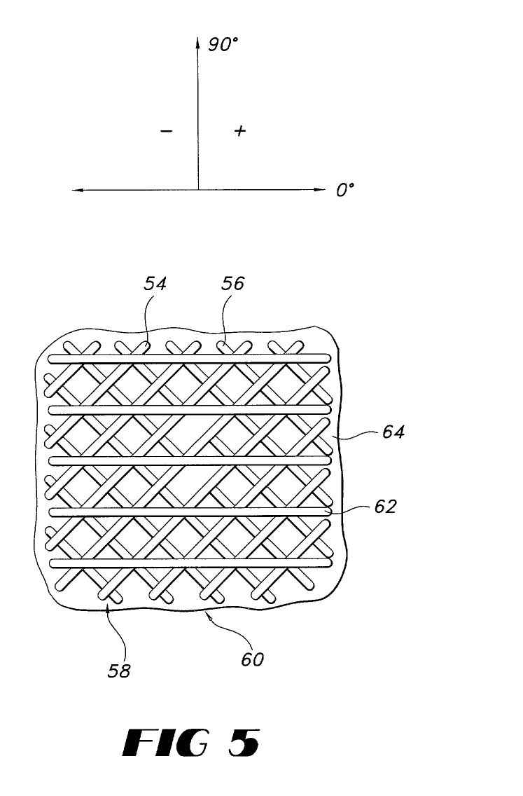

A tri-axial nonwoven weatherable fabric is also a desirable embodiment of the present invention. As shown in FIG. 5, the structure and composition of the fabric 60 duplicates the above described fabric, except a single yam set 62 with a 0° orientation replaces the first scrim having the yam sets with a 0°-90° orientation. The single yam set 62 may be positioned on top or underneath the second scrim 58. An outer layer 64 may coat both the single yam set 62 and the second scrim 58 on one or both sides. The second scrim 58 possesses warp and weft yam sets with directionally bias orientations. In a preferred embodiment, the warp yam set 54 of the second scrim 58 extends in a +60° direction, while the weft yam set 56 extends in a −60° direction. The angles of the yarn sets, however, may vary between +30° to +60° and −30° to −60°, respectively. Having yams oriented without crimp in three directions provides many of the same advantages over conventional structural fabrics as the above-described fabric, including greater strength especially in the yarn directions.

The weight of the scrim and the fabric may vary depending on the fabric's use. Where a more durable and weatherable fabric is needed, a heavier scrim and fabric may be more advantageous. Where external forces are less of a concern, a lighter scrim and fabric may be sufficient. In preferred embodiments, the weight of each scrim may range from 2-6 oz./yd², while the fabric weight may range from 10-30 oz./yd².

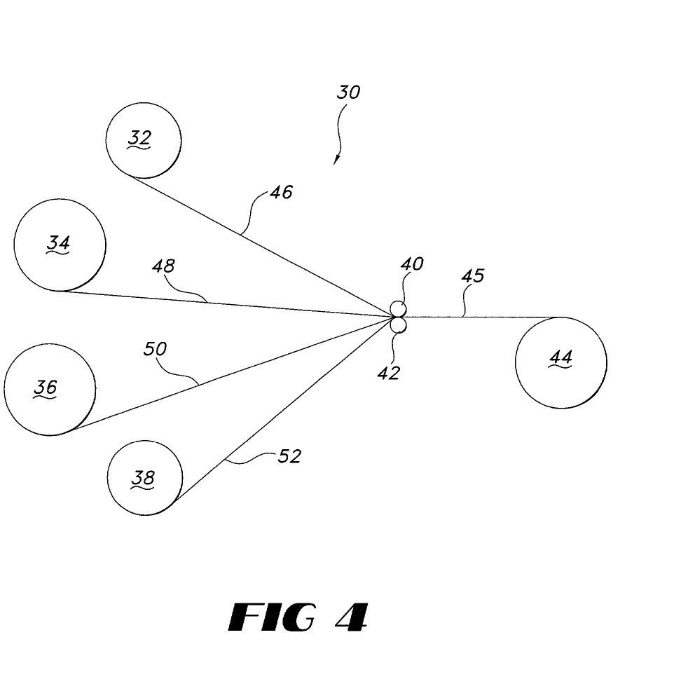

FIG. 4 depicts a possible process of manufacture 30 that would enable unitary pre-manufactured scrims 48 and 50 to be appropriately positioned and covered to form the fabric 45 of the present invention. Rolls of an outer layer material 32 and 38, such as a laminate, film, foil, or web are positioned, respectively, above and below the pair of rolls of pre-manufactured scrim 34 and 36, wherein one of the rolls of pre-manufactured scrim may be a warp or bolt of yarns. The covering material 46 and 52 and the scrims 48 and 50 feed a set of pressurized nip rolls 40 and 42. These nip rolls 40 and 42 also may be heated depending on the type of bonding to be performed. The nip rolls 40 and 42 cause the covering material 46 and 52 to bond with the scrims 48 and 50 forming the fabric 45 which is beamed onto a roll 44. Other processes of manufacture may be desirable, including using a coating process for bonding the scrims together by way of a liquid polymeric coating which is applied onto one or both sides of the scrims during manufacture and then allowed to solidify.

These multi-axial nonwoven fabrics of the present invention function particularly well in the tent and structure markets where curved and flowing lines are often used, as these fabrics have good dimensional stability in both the 0° and 90° directions as well as in the bias directions. The fabrics are stronger and more durable than existing semi-permanent structural fabrics, allowing them to better withstand the elements and other internal and external forces placed upon them. At the same time, the multi-axial nonwoven fabrics are lightweight enough to be manipulated and maneuvered by tent erection crews. These fabrics, because of their ease of manufacture, are also financially competitive with other less durable existing semi-permanent structural fabrics. For these and other reasons herein stated, the multi-axial nonwoven fabrics of the present invention are patentable over the prior art.

These and other modifications and variations to the present invention may be practiced by those of ordinary skill in the art, without departing from the spirit and scope of the present invention. In addition, it should be understood that aspects of the various embodiments may be interchanged either in whole or in part. Furthermore, those of ordinary skill in the art will appreciate that the foregoing description is by way of example only, and is not intended to limit the invention.

that which is claimed:

1. A weatherable outdoor fabric for use as a covering in outdoor structures, said fabric comprising:
a first scrim layer comprising a plurality of warp strands and a plurality of weft strands extending transversely to the plurality of warp strands, said plurality of warp strands being in a superimposed relationship with said weft strands such that the warp and weft strands are not interwoven;
a second scrim layer comprising a plurality of warp strands and a plurality of weft strands extending transversely to the plurality of warp strands, said plurality of warp strands being in a superimposed relationship with said weft strands such that the warp and weft strands are not interwoven;
a first weatherable polymeric layer affixed to a side of said first scrim layer; and
a second weatherable polymeric layer affixed to a side of said second scrim layer;
wherein said first and second scrim layers are affixed to each other with the respective polymeric layers facing away from the other of the scrim layers to define a fabric wherein both the scrim layers are protected from weathering between the first and second weatherable polymeric layers; and
wherein the first and scrim layers are superimposed with respect to each other such that the respective warp and weft strands are not parallel to each other and the fabric includes at least four strength axes defined by the strands.

2. A weatherable outdoor fabric as defined in claim 1 wherein the first and second weatherable polymeric layers comprise a vinyl-based compound.

3. A weatherable outdoor fabric as defined in claim 2 wherein the first and second weatherable polymeric layers comprise a polyvinyl chloride.

4. A weatherable outdoor fabric as defined in claim 1 wherein the strands comprise bundles of polyester filaments.
